(19) United States
(12) Patent Application Publication
(10) Pub. No.: US 2025/0239122 A1
(43) Pub. Date: Jul. 24, 2025

(54) OFFLINE METHOD FOR CLEARLY MARKING AND IDENTIFYING PHYSICAL OBJECTS

(71) Applicant: Fraunhofer-Gesellschaft Zur Förderung Der Angewandten Forschung E.V., München (DE)

(72) Inventors: Waldemar Berchtold, Darmstadt (DE); Tobias Jochum, Hamburg (DE); Jan Niehaus, Hamburg (DE); Christopher Krauss, Berlin (DE); Stephan Steglich, Berlin (DE); André Paul, Berlin (DE); Bert Fischer, Potsdam (DE); Martin Steinebach, Darmstadt (DE); Armin Wedel, Potsdam (DE)

(21) Appl. No.: 18/726,842

(22) PCT Filed: Jan. 13, 2023
(86) PCT No.: PCT/EP2023/050693

§ 371 Date: Jul. 5, 2024

(30) Foreign Application Priority Data
Jan. 13, 2022 (DE) 102022100731.6

(51) Int. Cl. G07D 7/0043; B41M 3/14; G07D 7/005; G07D 7/2033

(52) U.S. Cl. CPC G07D 7/0043; B41M 3/144; G07D 7/005; G07D 7/2033

(57) ABSTRACT

The present invention relates to a method for clearly marking and a method for identifying physical objects, a method for offline verification of a physical object, a method for hybrid offline and online verification of a physical object, a method for expanding the marking by further unique codes, a physical object having an optical security feature for clearly marking and identifying, a serialization and/or track & trace system based on an optical security feature such as this, and the use of an optical security feature such as this in a serialization and/or track & trace system and/or for object authentication, for offline verification and/or hybrid offline and online verification of a physical object and in a method for expanding the marking by further unique codes.

The present invention relates to a method for clearly marking and to a method for identifying physical objects, to a method for off-line verification of a physical object, to a method for hybrid off-line and online verification of a physical object, to a method for expanding the marking to include other unique codes, to a physical object having an optical security feature for clearly marking and identifying, to a serialization and/or track & trace system based on an optical security feature such as this and to the use of an optical security feature such as this in a serialization and/or track & trace system and/or for object authentication, for off-line verification and/or hybrid off-line and online verification of a physical object and in a method for expanding the marking to include other unique codes.

### TECHNICAL BACKGROUND

In the current coronavirus pandemic, it is becoming clear how prone globally networked supply chains and collaborative networks (in Industry 4.0) are to counterfeit products. At present, large pharmaceutical companies are warning that potentially counterfeit drugs or aids may reach the end customers on unlicensed sales channels or through unlicensed suppliers in periods of the pandemic. Among other things, inferior protective mouth-and-nose masks with counterfeit certificates, counterfeit vaccines and also counterfeit vaccination certificates and test documents are being put onto the market.

To prevent counterfeit products, the process and supply chains in the worldwide economy need to be made traceable and resilient through product authentication. Counterfeit certificates or products are identified in this way and appropriate measures can be taken immediately. Authenticating a product requires data. These data need to be securely stored. The following points need to be satisfied in order to be deemed secure:
integrity of the data relating to the product
authenticity of the manufacturer of the product
availability of the data needed for verification
protection of the users' privacy

All-encompassing product protection can be ensured only by an end-to-end system from the originator through e.g. customs, wholesalers and retailers to the end customer. Everyone in this chain must be capable of securely authenticating a product.

In the battle against counterfeit products, various technologies have become established worldwide that offer different approaches to a solution for the problems outlined in point 1.

Approaches to a solution from serialization and track & trace based on digital databases should be mentioned as dominating the market. These are used to record the clear tracking and tracing of process steps in the production chain. Moreover, (additional) product information can be transferred here. This requires information storage media that have been put onto the product and have the link to the database entry as their content. The information stores used are primarily radio frequency identifiers (RFID) or barcodes. The former are used to communicate by way of electromagnetic waves, the latter by way of light waves. Barcodes are generally widely used since they can be easily generated and also read by anyone. These have several weaknesses:
Easily copyable and transferable
Although end customers can read the content of the barcode, they have only very limited opportunities for product verification, since database access is possible only by a few individuals in the supply chain.
Database connectivity is prone to external influences, e.g. network outages and cyber attacks.

A distinction is drawn in this case between a 1-dimensional barcode (dash-dot), 2-dimensional barcode (QR code), 3-dimensional barcode (e.g. color barcode) and the 4-dimensional barcode (e.g. color barcode displayed on a display in a manner altered over time), and the 5-dimensional barcode (color QR code providing for not only time but also fluorescence as other dimensions).

In the case of serialization and track & trace, every product is provided with an identity. A distinction is drawn in this case between 3 types of identities.
Identity (ID): used to identify articles or manufacturers (classes of entities), e.g. barcode with EAN (European article number system) on food packaging
Clear identity: used to identify individual entities, e.g. DataMatrix with individual serial number for every medicament packaging. The individual serial number is generated externally (human beings or machines) and is not connected directly to the product/object.
Secure and clear identity: used to identify and authenticate individual entities, e.g. QR code with second factor inseparably linked to the entity, e.g. by virtue of a fingerprint of the object being stored in digitally signed form in a QR code. Secure identity means that it cannot be manipulated, counterfeited, transferred/copied or misused.

Individual authentication requires all products to be distinguishable from one another. There are to this end primarily two approaches to achieving distinguishability in the literature. Individualization is achieved either through clear marking, e.g. by means of digital watermarks or serialization, or by extracting production inaccuracies, e.g. as a fingerprint or physically unclonable function. Not until the 2010s was it possible for product authentication solutions based on production inaccuracies (woven substrate, paint splatters and printing inaccuracies in barcodes) to be established.

DE 10 2021 109 455.0 describes a method for clearly marking and identifying products by means of clear marking on the basis of product inaccuracies.

However, a partially unsolved data protection challenge for today's established solutions is when end customers are also involved, since databases are used (see availability and privacy). The demands and implementation of IT security lead to complex architectures and high costs, both for establishing and for operating an applicable solution.

For this reason, off-line product authentication that requires no database connectivity from the end customer has been developed in the present invention; the end customer can still carry out product authentication, however, because the data for verification are made available with the product. The solution can therefore be implemented at no great cost, and data protection is complied with.

### SUBJECT MATTER OF THE INVENTION

The present invention relates to a method for clearly marking physical objects, containing the following steps:
defining a first area on at least one surface of a physical object;
extracting features from the selected area;
producing a clear identity from at least some of the extracted features;
signing at least the clear identity and optionally other information in the form of a digital signature;
producing a unique code containing at least the clear identity, the optional other information and the digital signature;
printing the unique code onto at least one second area on at least one surface of the physical object.

In addition, the invention relates to a method for identifying a physical object that has been marked using the method of clear marking as described herein, the method containing the following steps:
scanning the printed unique code containing at least the clear identity, the optional other information and the digital signature;
reading the clear identity, the optional other information and the digital signature from the unique code;
verifying the digital signature;
checking whether the digital signature relates to the clear identity and the optional other information in the unique code;
extracting features from the at least one defined first area;
comparing the extracted features against the clear identity that has been read from the unique code.

Furthermore, the invention relates to a method for off-line verification of a physical object by using the methods for clearly marking physical objects and identifying a physical object as described herein, wherein no data for clear identification, preferably selected from features extracted from the defined first area of the physical object, data pertaining to the clear identity and possibly other object data, for example date of manufacture, place of manufacture, batch number, validity data such as expiration date, and references to further digital media such as Internet links to packaging leaflets or instructions for use or digital representations, are retrieved from a database for clearly identifying the physical object.

Moreover, the invention relates to a method for hybrid off-line and online verification of a physical object by using the methods for clearly marking physical objects and identifying a physical object as described herein, wherein some of the data for clear identification, preferably selected from at least some of the features extracted from the defined first area of the physical object, and/or other data for verifying the digital signature, for example public keys or digital certificates, are stored in a database and retrieved therefrom.

In addition, the invention relates to a method for expanding the marking to include other unique codes, wherein at least some of the steps for marking the physical object and at least some of the steps for identifying the marked physical object in the methods for clearly marking physical objects and identifying a physical object as described herein are carried out and pursued by every inspection authority in the life cycle of a physical object, for example manufacturers, customs, wholesalers and traders, the signed clear identity in the case of the additional unique code that is to be newly put on relating not to extracted features but rather to a representation (for example hash value of the data) of the most recently added unique code.

The invention also relates to a physical object having an optical security feature for clearly marking and identifying, preferably for clearly and securely marking and identifying, physical objects on at least one area of the surface of the physical object,
wherein the optical security feature comprises at least one first defined area and at least one second area having at least one printed unique code,
the at least one printed unique code containing a clear identity, optionally other information pertaining to the physical object and a digital signature of the clear
identity and the optional other information,
the clear identity having been produced from features that have been extracted from the at least one first defined area.

Additionally, the invention relates to a serialization and/or track & trace system based on at least one optical security feature on at least one surface of a physical object as described herein.

Moreover, the invention relates to the use of an optical security feature on at least one surface of a physical object as described herein in a serialization and/or track & trace system and/or for object authentication.

Furthermore, the invention relates to the use of an optical security feature on at least one surface of a physical object as described herein for off-line verification and/or hybrid off-line and online verification of a physical object.

Finally, the invention relates to the use of an optical security feature on at least one surface of a physical object as described herein in a method for expanding the marking to include other unique codes as described herein.

### Definitions

The term “clear marking” within the context of the present invention means that an adequate number of individual marks is available to individualize each entity in a group of products that is to be marked. Each individual mark differs here from the other individual marks in at least one feature. As such, for a group of 1 million products in total, for example, at least 1 million individual marks need to be available that differ from one another in at least one feature.

The term “secure and clear marking” within the context of the present invention includes a clear and distinctive marking, by way of a clear marking, as defined above (e.g. a unique serial number that is preferably inseparably integrated in the product or document, e.g. through evaluation of features, e.g. production inaccuracies), that is protected by cryptographic methods (e.g. a digital seal), so that transfer to another product or document results in the verification (checking/reading) of the marking failing.

The term “physical object” includes any type of item. This is geared here to the material property of the object, in contrast to immaterial goods, such as services. The physical object within the context of the invention is here normally part of a series of physical objects that is able to be clearly marked and identified using the present invention. By way of example, the physical object includes products and the intermediate stages thereof, commodities, documents and machines. Some examples of products and the intermediate stages thereof or commodities are as follows: a branded product, a consumer product, a pharmaceutical product, a health product, a nutrition product, a component, a hardware component, an electronic component, a computer chip, a book, a manual. Besides the physical object itself, insofar as it can be used for defining an area on the surface and extracting features from this surface, the term also includes the packaging, product labels (tags), barcode cards and barcode labels thereof, and also all other possibilities that would normally be used to mark a physical object during the production process and/or transportation.

The term “documents” within the context of the present invention as a subunit of the term “physical objects” and “printable physical objects” includes (possibly printed) substrates, such as (possibly printed) natural, cellulose-based substrates, (possibly printed) artificial polymer-based substrates and mixtures thereof, in particular banknotes, ID cards, passports, birth certificates, driver's licenses, entry tickets and other tickets. A few other examples are as follows: a check, a bond, a bank card, a credit card, a check card, a currency, a cash card, an identifying item, an identity item, an entrance item, an item for issuing a permit, a personal ID card, a social insurance certificate, a driver's license, a vaccination certificate, a test certificate, a health card, an insurance card, a personalized item, a passport, a document, a paper document, a security document, a postage stamp, a personalized document, an ad hoc document, a certificate, a share certificate, a debt certificate, a contract, an insurance policy, a will, a parking ticket, a transportation ticket, or a ticket for admission to an event.

The term “printing composition” within the context of the present invention includes any desired composition that can be used e.g. as an ink formulation or toner in the printing methods specified below. The printing composition may be a liquid printing composition, for example an ink formulation, or a solid or powdered printing composition, for example a toner.

The term “ink formulation” within the context of the present invention includes any desired solvent and combinations thereof and also typical additives that are suitable for manufacturing a liquid that can be used for printing.

The term “toner” within the context of the present invention comprises any desired solid or powder composition and combinations thereof and also typical additives that are suitable for manufacturing a solid or powder that can be used for printing.

The term “ideal first area” is an ideal image of the defined first area without visual variances. The defined first area is here normally a possibly partially or completely printed area on at least one surface of the physical object as defined above.

The term “original digital image” within the context of the present invention includes the digital image generated that is printed onto the physical objects using the printing composition. If the defined first area is completely printed, the original digital image can replace the ideal first area.

The term “features” within the context of the invention includes any type of visual variance on the defined first area of the physical object in relation to the examined area of identical physical objects, in relation to the ideal first area and possibly in relation to its original digital image. The features may be for example variances in the texture of the area, color of the area, inclusions, recesses and variance in the printed image. These variances may be production inaccuracies as defined below or alternatively variances that have been deliberately introduced onto the surface of the physical object, into the printing composition or into the printed image by the manufacturer or issuer. Deliberate variances may be for example intentional manipulations of the surface of the product, for example through the addition of foreign bodies or the addition of cavities, added substances, such as pigments, to the printing composition, specific defects or color errors in the printed image, or the like.

The term “production inaccuracy” within the context of the present invention includes all possible fluctuations in the production or manufacturing process for physical objects and fluctuations in printing processes, with the result that an individual feature image bound to a physical object is obtained. In addition, within the context of the present invention, the term includes unintentional and intrinsic variances of the examined area of the physical object in relation to the examined area of identical physical objects and in relation to its original digital image. These unintentional and intrinsic variances may be variances of the surface of the physical object itself, variances in a printed printing composition or variances in the printed image of an identification pattern printed using a printing composition. Examples of variances of the surface of the physical object are surface irregularity, differences in the fiber structure and/or fiber thickness, holes, protrusions, scratches, edge contours, granularity, roughness and haziness. Examples of variances in the printed printing composition are variances in viscosity, surface tension or particle size, particle agglomerations, etc. Examples of variances in the printed image of the identification pattern printed using the printing composition are printing inaccuracies and printing defects such as different line thicknesses, line paths, line widening, edge contours, satellite drops, multiple ink drops on an area, no ink drops, which are attributable to individual errors and incorrect settings of the printer, for example lack of a printing impulse, clogging or incorrect setting of the printing nozzles or inconsistent guidance of the substrate and/or printing head. The term “production inaccuracies” does not cover variances that have been deliberately introduced onto the surface of the physical object, into the printing composition or into the printed image by the manufacturer or issuer, for example intentional manipulations of the surface of the product, for example through the addition of foreign bodies or the addition of cavities, added substances, such as pigments, to the printing composition or specific defects or color errors in the printed image.

The term “extraction of the features” within the context of the present invention includes the measurement and evaluation of visual variances of the defined first area in relation to the ideal first area, or its original digital image. This is because in reality almost all surfaces of physical objects have visual variances. These may not be perceptible to the human eye and therefore often require optical measuring equipment such as e.g. a spectrometer, camera or smart devices.

If variances can be measured during a recording using optical measuring equipment, such as e.g. a spectrometer, camera or smart devices, the present invention refers to said variances as a feature.

The term “printing” within the context of the present invention includes the deposition of pigments on or in a solid substrate. Typical examples are, but not exclusively, offset printing, digital printing, inkjet printing, screen printing, transfer printing, stamp printing, roll to roll, contactless printing, laser printing, spray printing, spray processes, thermal printing, thermal transfer printing, and other methods.

The term “off-line verification” describes the check on the authenticity of the manufacturer or issuer of the physical object and integrity of the data relating to the product using the data needed for verification. The data needed for verification are stored in the unique code, the digital certificates either also being able to be stored in the unique code or being able to be stored in the verifying application or being able to be loaded from a database.

The term “unique code” describes a one- or multidimensional code that is produced individually for each entity in a group of similar entities and differs from all other unique codes of the entities thereof in the group.

A “digital certificate” is a digital dataset that, besides certain metadata, for example a name, town, country, relating to a legal or natural person, also bears the public key of this person, and the signature of these data by a trusted instance. The trusted instance uses its signature of the digital certificate to confirm the authenticity of a person, said authenticity then becoming verifiable. The integrity of the data can be tested by decrypting the data using the public key of the signatory and cryptographic methods. The digital certificate is normally issued by an official certificate authority.

A “digital signature” is an asymmetric cryptosystem that involves a sender using a secret signature key (the private key) to compute a value for a digital message (i.e. for arbitrary data), said value also being called a digital signature. This value permits anyone to use the public verification key (the public key) to test the undeniable authorship and integrity of the message. In order to be able to attribute a signature produced using a signature key to a person, the related verification key must be unequivocally associated with this person (see https://de.wikipedia.org/wiki/Digitale_Signatur).

Photoluminescence refers to the emission of photons following prior excitation by means of photons of higher energy, mostly in the ultraviolet but also in the visible or near infrared range. The excitation raises an electron to a higher energy state. When it falls back to a lower energy state, this energy is released again in the form of photons. In a luminescent substance, a coarse distinction is drawn between two types of excitation: in the case of fluorescence, the electron falls from a higher singlet state back to the lower energy state, while in the case of phosphorescence, the excited electron transitions into an elevated triplet state by way of a transition that is prohibited according to spin selection, from which it again falls back to the lower energy state by way of a transition that is prohibited according to spin selection.

Blockchain is a continuously expandable list of datasets in individual blocks. New blocks are produced using a consensus method and appended to an existing chain by means of cryptographic methods. In an analogous code chain, the datasets are not stored in a database, but rather are stored on the physical object itself. New blocks can likewise be appended to an existing chain by means of the method described.

### DETAILED DESCRIPTION OF THE INVENTION

The essence of the present invention is the use of individual intrinsic features of the surface of a physical object as a physical unclonable function for securely marking and identifying a physical object. These features are extracted from a defined first area of the surface by means of imaging methods, for example, and are used as a basis for a clear identity, for example in the form of a binary code. The clear identity is additionally signed and converted, together with this signature, into a unique code that is printed onto a second area of the surface of the physical object. This unique code therefore firstly contains a physical unclonable function for securely identifying the physical object, and also the signature of the author for verifying the authenticity. On the basis of these two pieces of information, it is possible to dispense with central storage of data for identifying and/or authenticating the physical object, for example storage of a key for decrypting a serial number in a central database.

A first aspect of the present invention relates to a method for clearly marking physical objects, containing the following steps:
defining a first area on at least one surface of a physical object;
extracting features from the selected area;
producing a clear identity from at least some of the extracted features;
signing at least the clear identity and optionally other information in the form of a digital signature;
producing a unique code containing at least the clear identity, the optional other information and the digital signature;
printing the unique code onto at least one second area on at least one surface of the physical object.

In a first step, a first area on at least one surface of a physical object is defined. This at least one defined area is normally communicated to all inspection authorities in the life cycle of the physical object, for example manufacturers, customs, wholesalers and traders, in order to permit identification of the physical object using the inventive method described herein, off-line verification of the physical object using the inventive method described herein and expansion of the marking to include other unique codes using the inventive method described herein.

Every surface of a physical object is unique and has individual intrinsic features, for example production inaccuracies (cracks, elevations, troughs, roughness, etc.). These are non-visible to a human eye, and also accidental, random, and are today deemed uncontrollable in the production process. The term physical unclonable function is therefore also used.

Since every portion of a surface of a physical object is clearly different from any other on the surface and also from portions of other surfaces, the first area can be individually selected and defined. It is also possible to select whether features are extracted from the entire defined first area or only from a portion of the first area. It is merely necessary to ensure that the number of features still leaves the physical objects to be marked clearly distinguishable. The selection is then normally communicated to a reading unit/extraction unit and to all inspection authorities in the life cycle of the physical object.

One or more first areas can be defined in this process. For cost reasons alone, the number of first areas does not normally exceed 10. The number of surfaces of the physical object to be marked is dependent on the type and shape of the physical object to be marked. First areas on one or more surface(s) of the physical object to be marked can be defined. The number of surfaces does not normally exceed 10.

This at least first area may be an area on any type of surface associated with the physical object, for example at least one area of the surface of the physical object directly, insofar as the characterization of the physical object so permits, at least one area of the surface of the packaging of the physical object, at least one area of a label, tag, barcode card and/or barcode label with which the surface of the physical object is posted or labeled, or combinations of these (e.g. a portion of the surface of the physical object or packaging of the physical object in combination with at least one portion of the area of a label, tag, barcode card and/or barcode label).

The same area(s) on the at least one surface of the physical object is preferably defined for every entity of the number of physical objects that is to be marked.

The minimum size of the at least one first area is dependent on the number of entities of a physical object that are to be marked. The greater the number of entities, the greater the minimum size of the at least one first area. The at least one first area needs to be chosen to be large enough for the number of extracted features to suffice to individualize every entity. The at least one first area normally has a size of less than 10 cm².

At least part of the at least one defined first area may be printed with at least one printing composition.

The at least one printing composition(s) may be printed here directly onto at least one portion of the at least one defined first area on at least one surface of a physical object, insofar as the characterization of the physical object so permits. The at least one printing composition(s) can also be printed onto at least one label, and at least one surface of the physical object, at least part of which surface overlaps the defined first area, can then be posted/labeled with the at least one printed label.

If the shape and/or characterization of the physical object does not permit printing, the at least one first area can also be defined on the surface of the packaging of the physical object, and at least part of the at least one printing composition(s) can be printed directly onto at least one defined first area of the surface of the packaging of the physical object. It is also possible for at least one label printed with the at least one printing composition(s) to be adhered/affixed to at least one portion of the at least one first defined area on the surface of the packaging of the physical object. The printing composition(s) can also be printed onto documents.

Printing on at least one portion of the defined surface expands the selection of features to be extracted to features that are based on variances in the printed image or in the printing compositions on the printed area. This allows the size of the at least one defined first area to be reduced in accordance with the proportion of the printed area.

The standard printing methods can be used for printing, according to the type of the printing compositions. The printing compositions are preferably printed onto at least one area of the surface of the physical object or document by means of offset printing, digital printing, inkjet printing, screen printing, transfer printing, stamp printing, roll to roll, contactless printing, laser printing, spray printing, spray processes, thermal printing, thermal transfer printing, and other methods.

Depending on the type of product, the printing composition(s) can be printed directly onto at least one surface of the physical object, onto the packaging of the physical object and onto labels, signs, barcode cards and/or barcode labels.

The printing composition(s) is/are preferably (a) commercially available printing composition(s) suitable for depositing pigments onto or into a solid substrate. Suitable printing compositions may be liquid printing compositions such as ink formulations or solid or powdered printing compositions such as toners, depending on the type of printing. Typical examples are, but not exclusively, offset printing, digital printing, inkjet printing, screen printing, transfer printing, stamp printing, roll to roll, contactless printing, laser printing, spray printing, spray processes, and other methods.

The printing composition(s) may contain color pigments. The color pigments are preferably commercially available color pigments suitable for printing compositions. This can result in the print on the defined area being visible to the human eye.

The printing composition(s) may contain photoluminescent materials that emit radiation in the range up to 3000 nm, preferably up to 1800 nm, more preferably up to 1400 nm, most preferably up to 1100 nm, under photon excitation.

In general, this is suited to photoluminescent materials that emit radiation from at least 200 nm, preferably at least 225 nm, more preferably at least 250 nm, as the lower limit, under photon excitation.

In one preferred embodiment, the photoluminescent materials emit radiation from at least 380 nm, preferably from at least 390 nm, most preferably from at least 400 nm, as the lower limit, under photon excitation.

In another preferred embodiment, the photoluminescent materials emit radiation from at least 750 nm, preferably from at least 780 nm, more preferably from at least 800 nm, most preferably from at least 850 nm, as the lower limit, under photon excitation.

The photoluminescent materials are preferably selected from photoluminescent dyes and semiconducting inorganic nanocrystals.

The semiconducting inorganic nanocrystals preferably emit radiation in the range from 400 nm to 3000 nm, more preferably from 500 nm to 1800 nm, most preferably from 750 nm to 1100 nm, under photon excitation.

Examples of suitable semiconducting inorganic fluorescent (core) nanocrystals are, inter alia, Ag₂S, Ag₂Se, Ag₂Te, CdS, CdSe, CdTe, PbS, PbSe, PbTe, SnTe, ZnS, ZnSe, ZnTe, InP, InAs, Cu₂S, In₂S₃, InSb, GaP, GaAs, GaN, InN, InGaN, ZnSSe, ZnSeTe, ZnSTe, CdSSe, CdSeTe, HgSSe, HgSeTe, HgSTe, ZnCdS, ZnCdSe, ZnCdTe, ZnHgS, ZnHgSe, ZnHgTe, CdHgS, CdHgSe, CdHgTe, ZnCdSSe, ZnHgSSe, ZnCdSeTe, ZnHgSeTe, CdHgSSe, CdHgSeTe, CuInS₂, CuInSe₂, CuInGaSe₂, CuInZnS₂, CuZnSnSe₂, CuIn(S,Se)₂, CuInZn(S,Se)₂ and AgIn(S,Se)₂.

Other suitable examples, but not exclusively, are perovskite materials having the general formula ABX₃ or A₄BX₆, X being able to be selected from Cl, Br, I, O and/or mixtures thereof, A being able to be selected from Cs, CH₃NH₃, CH(NH₂)₂, Ca, Sr, Bi, La, Ba, Mg and/or mixtures thereof, B being able to be selected from Pb, Sn, Sr, Ge, Mg, Ca, Bi, Ti, Mn, Fe and/or mixtures thereof.

In addition, core/shell and/or core/multishells of semiconducting inorganic nanocrystal architectures of II-VI, III-V, IV-VI, I-VI, I-III-VI semiconductors or mixtures thereof and core/shell and/or core/multishells of perovskite materials are other suitable examples.

The crystal lattice of the semiconducting inorganic nanocrystals may additionally, but not exclusively, be doped with one or more metal ions, for example Cu⁺, Mg²⁺, CO²⁺, Ni²⁺, Fe²⁺, Mn²⁺ and/or with one or more rare earth metals, for example ytterbium, praseodymium or neodymium.

The semiconducting inorganic nanocrystals preferably have an average particle size of 1 nm to 100 nm, more preferably from 2 nm to 50 nm, and most preferably from 3 nm to 15 nm in at least one dimension, preferably in all dimensions.

The average particle size can be further increased/modified by way of various methods. Typical examples are, but not exclusively, a silica shell, a titanium oxide shell, a halogen shell and other methods for increasing stability, masking, biocompatibility, water solubility and/or coating.

A useful property of the preferred semiconducting inorganic nanocrystals is that the excitation and emission spectrum thereof is, inter alia, dependent on the particle size thereof.

The semiconducting inorganic nanocrystals are preferably photoluminescent substances that are taken to electronically excited energy states through light absorption, and then return to lower-energy states by emitting light in the form of fluorescence.

The printing composition(s) may also contain, instead of or in addition to the photoluminescent semiconducting inorganic nanocrystals, one or more other photoluminescent dyes.

The photoluminescent dyes preferably emit radiation in the range from 380 to 3000 nm, preferably from 400 to 1800 nm, more preferably from 450 to 1400 nm, most preferably from 750 nm to 1100 nm, under photon excitation.

The photoluminescent dyes can be selected from fluorescent dyes, phosphorescent dyes and mixtures thereof.

Fluorescent dyes are dyes that emit fluorescent radiation after photon excitation, whereas phosphorescent dyes are dyes that emit phosphorescent radiation after photon excitation.

Suitable photoluminescent dyes may exhibit both a Stokes shift and an anti-Stokes shift under photon excitation. In addition, luminescent materials may exhibit both fluorescence and phosphorescence behavior. The luminescent materials used may be either organic or inorganic crystals/molecules.

Fluorescent dyes are normally selected from organic fluorescent dyes and inorganic fluorescent dyes or mixtures thereof.

Organic dyes may be selected from the classes of the proteins and peptides, small organic molecules, synthetic oligomers and polymers, and multicomponent systems.

Typical examples of polymers and peptides are green fluorescent protein (GFP), yellow fluorescent protein (YFP) or red fluorescent protein (RFP).

Non-protein organic fluorescent dyes normally belong to the classes of the xanthene derivatives, cyanine derivatives, squaraine derivatives, squaraine-rotaxane derivatives, naphthalene derivatives, coumarin derivatives, oxadiazole derivatives, anthracene derivatives, pyrene derivatives, oxazine derivatives, acridine derivatives, arylmethine derivatives, tetrapyrrole derivatives and dipyrromethane derivatives.

Organic fluorescent dyes are normally commercially available in all emission spectrum colors from blue (from 380 nm upward) to red (up to 1800 nm).

Suitable organic dyes with emission spectrum colors from 800 nm upward are described here for example in EP 0 933 407, U.S. Pat. Nos. 5,282,894, 5,665,151, WO 1998/018871, WO 2003/038003, U.S. Pat. Nos. 10,119,071 and 5,542,971.

Suitable inorganic dyes are preferably the semiconducting inorganic nanocrystals described above.

Phosphorescent dyes are normally selected from doped oxides, nitrides, oxynitrides, sulphides, selenides, halides, silicates and aluminates of calcium, strontium, barium, zinc, cadmium, manganese, silicon and rare earth metals and mixtures thereof. In most cases, but not exclusively, sulphides of metals from group II of the periodic table and zinc and aluminates of metals from group II of the periodic table are used. The doping substances can be e.g. metals or metal salts.

Suitable examples of phosphorescent dyes are doped sulphides and aluminates of calcium, strontium, barium and zinc, for example bismuth-doped calcium/strontium sulphide, copper-doped zinc sulphide, and europium-doped strontium aluminate.

Photoluminescent dyes with Stokes shift behavior are preferably photoluminescent substances that are taken to electronically excited energy states through light absorption of a higher-energy photon, and then return to lower-energy states by emitting light in the form of fluorescence or phosphorescence.

The photoluminescent materials are preferably excited by visible light, such as blue or white light, and higher-energy NIR radiation as the emission signal.

The photoluminescent materials emit radiation with a wavelength in the range from 200 nm to 3000 nm in the broadest spectral range under photon excitation, as discussed above.

In a particularly preferred embodiment, the photoluminescent materials emit radiation with a wavelength in the range from 750 to 1800 nm, more preferably from 800 to 1400 nm, most preferably from 850 nm to 1100 nm, under photon excitation. These wavelength ranges are in the non-visible near infrared range (NIR range).

The proportion of the photoluminescent materials in the printing composition is preferably 0.01 to 70.0 wt %, more preferably 0.05 to 40.0 wt %, most preferably 0.1 to 30.0 wt %, measured based on the total weight of the printing composition. For digital and inkjet printing, a range between 0.01 and 30.0 wt % is preferable.

The printing composition may contain photoluminescent materials that have at least one or all, preferably all, of the following properties in common: emission wavelength, emission distribution and emission maximum. In another embodiment, the printing composition may contain mixtures of photoluminescent materials that have different values for emission wavelength, emission distribution and emission maximum.

Furthermore, the printing composition may contain the color pigments of the commercial toners or inks. Commercial printing compositions can be used, and these can be mixed with the photoluminescent materials.

The emitted radiation of the printing composition may yield an individual fluorescence spectrum that is dependent on the type, volume and particle size of the photoluminescent materials, preferably the semiconducting inorganic nanocrystals. The individual fluorescence spectrum can be detected here using a spectrometer. The detected individual fluorescence spectrum can then be compared with a reference spectrum that has already been stored.

In addition, this individual fluorescence spectrum can be used as another security feature for a printing composition individually mixed by the manufacturer of the product.

The printing compositions for inkjet printing, for example, preferably have a reciprocal Ohnesorge number of less than 14, more preferably from 1 to 10, even more preferably from 1 to 8, and most preferably from 2 to 4.

The one or more printing composition(s) may contain exclusively color pigments, exclusively photoluminescent materials as described above or color pigments and photoluminescent materials as described above.

Preferably, at least one surface of a physical object is printed with at least one printing composition in the form of an identification pattern.

In this case, the inventive method preferably comprises the following further steps:
providing one or more printing composition(s);
printing the printing composition(s) onto at least one surface of the physical object in the form of an identification pattern,
   wherein at least part of the printed identification pattern overlaps the at least one defined first area.

The identification pattern may also contain one or more patterns, for example areas, stripes, lines, geometric figures, such as circles, triangles, rectangles, polygons, etc., alphanumeric characters, characters, images or combinations thereof.

The identification pattern may be unique to each individual printable physical object to be marked. This means that the identification pattern of every entity of the physical objects to be marked differs from the identification patterns of the other entities in at least one feature.

The identification pattern may contain object data, for example date of manufacture, place of manufacture, batch number, validity data such as expiration date, and references to further digital media such as Internet links to packaging leaflets or instructions for use or digital representations.

The identification pattern may be one- or multidimensional.

Suitable dimensions for the multidimensional identification pattern are spatial dimensions, for example in the x and/or y direction, or color dimensions, for example the intrinsic color of the dyes in the printing compositions and/or the various emission spectra of the semiconducting inorganic nanocrystals.

The identification pattern may be a one-dimensional pattern, for example a barcode, a two-dimensional pattern, for example a QR code, or a three-dimensional pattern, for example a color barcode.

The identification pattern may also contain a unique code or be a unique code. The identification pattern for each individual physical object to be marked is preferably unique here.

This can be accomplished by preferably first digitally signing at least one reference variable, preferably multiple reference variables, pertaining to the physical object. Possible reference variables here are for example reference variables relating to the type and nature of the physical object such as serial numbers, lot numbers, CAS number in the case of chemical products, the place of production, the time of production, the place of delivery, the manufacturer, the supplier, the customer or the like.

The secure key can be made available to the manufacturer or produced by the manufacturer itself.

The digital signature is used to generate a code that is unique to the physical object, preferably to the individual packaging unit of the physical object. The digital signature allows the clear marking of the present invention to be used as secure and clear marking.

At least part of the at least one defined first area preferably overlaps the at least one printed surface of the physical object. The at least one defined first area may be larger than, smaller than or the same size as the at least one printed surface. The at least one defined first area may, but does not have to, be congruent with the at least one printed surface.

The at least one defined first area may, but does not have to, have the same shape as the printed surface.

At least part of the at least one defined first area preferably overlaps the at least one printed surface, for example in the range from 1% to 100%, such as 10% to 100%, preferably from 25% to 100%, more preferably from 50% to 100%, most preferably from 75% to 100%, of overlap.

This overlap allows the later extraction of the features from the at least one defined first area to also result in the detection of features that arise from visual variances in the printed printing composition or visual variances in the printed image of an identification pattern printed using the printing composition.

Features are extracted from the at least one defined first area.

Eligible features are all possible visual variances in the at least one defined area from the ideal first area without visual variances. Typical features are for example variances in the texture of the area, color of the area, inclusions, recesses and variance in the printed image.

If the at least one defined area completely overlaps the at least one printed surface, instead of the ideal first area it is also possible to use the original digital image of the at least one printed surface in the region of the at least one defined first area as a reference.

In one preferred embodiment, the features are production inaccuracies on the at least one defined first area.

The production inaccuracies extracted from the at least one defined first area include here all types of production inaccuracies, that is to say unintentional and intrinsic variances of the surface of the physical object and/or substrate itself and/or unintentional and intrinsic variances in the printed printing composition and unintentional and intrinsic variances in the printed image of an identification pattern printed using the printing composition, as described above.

The unintentional and intrinsic variances of the surface of the physical object and/or substrate are the result of random, uncontrollable processes during the production of the physical object and/or substrate itself. These production inaccuracies can be expanded in the inventive method to include unintentional and intrinsic variances in the printed printing composition and/or unintentional variances in the printed image of an identification pattern printed using the printing composition in the overlap between the at least one defined first area and the at least one printed surface of the physical object. These unintentional and intrinsic variances are the result of random, uncontrollable processes during the printing of at least one printing composition onto at least one surface of the physical object and according to the individual printing composition and the individual printer.

These production inaccuracies are therefore well suited to individualizing a physical object from a multiplicity of identical physical objects.

The features, preferably the production inaccuracies, are preferably extracted from the at least one defined first area using standard imaging methods, for example cameras, industrial cameras, NIR cameras, spectrometers, or else smart devices, such as smartphones or tablets. The accuracy of the imaging method is normally the subject of agreement in order to obtain comparable extraction for all steps.

Superficially, the at least one defined first area normally exhibits no kind of features, for example production inaccuracies. However, when the micrometer scale is considered, an individual pattern is usually recognizable. In inkjet printing, this can arise e.g. due to clogging of the printing nozzles, partial clogging of the printing nozzles, deflection of the ink drops or delayed deposition of the ink drop from the printing nozzle. This gives rise to a random pattern at micrometer level that is unique to every printing process. Together with the random and unique patterns of the other features mentioned above, such as production inaccuracies, this unique pattern can be attributed to a single physical object as a unique overall pattern by means of IT applications.

To ensure true individualization, depending on the number of entities of a physical object that are to be individualized, a corresponding number of features, preferably production inaccuracies, need to be identified and attributed to the individual entity. Since, statistically, only a certain number of features, preferably production inaccuracies, per square centimeter of the at least one defined first area can be expected in each case in each defined area, the number of individualizable entities is dependent on the area of the at least one defined first area.

The number of features, preferably production inaccuracies, per area of the at least one defined first area can be increased by expanding the selection of features, preferably production inaccuracies, to include features, preferably production inaccuracies, that can be detected in the spectral range up to 3000 nm, in particular to include the variances in the at least one printed printing composition or variances in the printed image of the at least one surface printed with the at least one printing composition in the overlap with the at least one defined first area and by expanding the detection spectrum, made possible by the printing composition used, from emissions in visible light (380 to 750 nm) by the standard commercially available photoluminescent materials to emissions in visible light and the shorter- and longer-wavelength spectral range from 200 to 3000 nm, especially in the near infrared range (up to 1800 nm, preferably up to 1400 nm, most preferably up to 1100 nm).

The at least one defined first area can be irradiated with photons and the features, preferably production inaccuracies, can be extracted in the range up to 3000 nm, preferably up to 1800 nm, more preferably up to 1400 nm, most preferably up to 1100 nm. Such irradiation is advantageous in particular if at least one of the printing compositions used contains photoluminescent materials that emit radiation in the range up to 3000 nm, preferably up to 1800 nm, more preferably up to 1400 nm, most preferably up to 1100 nm, under photon excitation. This allows the spectral range for extracting product inaccuracies to be expanded into the infrared range, preferably into the NIR range, and thus the number of extracted features, preferably product inaccuracies, on the at least one defined first area to be increased. White or blue light is normally used for the irradiation.

Following irradiation, the at least one defined first area, preferably the printing compositions on the at least one defined first area, more preferably the commercially available color pigments and/or photoluminescent materials as described above in the printing compositions, emit(s) radiation in the range from 200 to 3000 nm, preferably from 225 nm to 1800 nm, more preferably from 250 nm to 1400 nm, particularly preferably 250 nm to 1100 nm. In one preferred embodiment, the emitted radiation has a lower limit of 380 nm, preferably 390 nm, most preferably 400 nm. In another preferred embodiment, the emitted radiation has a lower limit of 750 nm, preferably 780 nm, more preferably 800 nm, most preferably 850 nm. It is quite particularly preferred for radiation in the range from 380 to 3000 nm, such as 380 to 1800 nm, preferably from 390 to 1400 nm, most preferably from 400 nm to 1100 nm, to be emitted.

Radiation in the range from 750 nm upward, e.g. from 750 nm to 1800 nm (NIR radiation), is imperceptible to the human eye. Instead, detection requires an electronic device that is able to detect the emitted radiation in the entire range up to 3000 nm, for example from 750 to 1800 nm, preferably from 800 to 1400 nm, most preferably from 850 nm to 1100 nm.

By way of example, suitable devices are spectrometers, industrial cameras, NIR cameras, or else smart devices, such as smartphones or tablets, which have in their camera systems a silicon-based image sensor that can detect incident photons up to a wavelength of approximately 1100 nm. These smart devices can also be used to excite the photoluminescent materials via the camera flash or the device LED. The flash can be controlled for excitation and detection purposes by way of an appropriate app, with the result that excitation and detection are followed, for example, by a corresponding photograph of the at least one defined first area appearing on the screen of the smart device.

On account of the higher density of production inaccuracies per area of the at least one defined first area, the increase in the number of production inaccuracies per area of the at least one defined first area allows the area of the at least one defined first area to be reduced to the range in which the at least one defined first area can be read using simple electronic and mobile smart devices, e.g. smartphones and tablets, or else spectrometers, NIR cameras or industrial cameras, by using appropriate software and the extracted features, preferably production inaccuracies, can be stored.

A defined first area having a maximum size of 10 cm² may thus suffice even for identifying individual entities from a number of physical objects in the region of several million.

For example, a defined first area having a maximum size of 10 cm² may suffice for identifying individual entities from a number of physical objects in the region of over 100 million.

A defined first area having a maximum size of 7 cm² may suffice for identifying individual entities from a number of physical objects in the region of up to 10 million.

A defined first area having a maximum size of 5 cm² may suffice for identifying individual entities from a number of physical objects in the region of up to 1 million.

A defined first area having a maximum size of 3 cm² may suffice for identifying individual entities from a number of physical objects in the region of up to 100 000. In another step, a clear identity is produced from at least some of the extracted features, preferably production inaccuracies.

The proportion of the extracted features, preferably production inaccuracies, from which the unique identity is produced is dependent on the number of extracted features, preferably production inaccuracies, and the number of entities to which a clear identity needs to be assigned. The proportion of the extracted features, preferably production inaccuracies, needs to be at least large enough for a clear identity to be able to be produced for every entity of a number of physical objects.

Although the inventive method is particularly suitable for off-line verification of a physical object, a hybrid approach may also involve data for verifying the physical object, such as the extracted features, preferably production inaccuracies, or other data, for example public keys or digital certificates for verifying the digital signature, being stored in a database. This permits online verification in addition to the off-line verification of the physical object, using the data stored in the database.

If only a proportion of the extracted features, preferably production inaccuracies, are used to produce the clear identity, all of the extracted features, preferably production inaccuracies, can still be stored in a database. This database can then be used for additional online verification of the physical object.

In addition to the extracted features, preferably production inaccuracies, the clear identity may contain other information.

This other information may include object data, for example date of manufacture, place of manufacture, batch number, validity data such as expiration date, and references to further digital media such as Internet links to packaging leaflets or instructions for use or digital representations.

The clear identity is normally a digital representation, preferably a character string.

This digital representation can be produced from the extracted features, preferably production inaccuracies, and the optional other information by way of an algorithm, preferably a hash algorithm.

A digital representation, preferably produced by way of an algorithm, preferably a hash algorithm, makes it impossible to generate an output dataset matching the hash algorithmically, i.e. other than by mere trial and error.

The digital representation normally has a size of at least 128 bits, such as 128 to 30 000 bits, preferably 256 to 20 000 bits, more preferably 512 to 10 000 bits.

Authentication of the physical object additionally requires a digital signature. The inventive method involves the manufacturer/distributor using the digital signature to sign at least the clear identity and optionally other information.

This other information may include e.g. object data, for example date of manufacture, place of manufacture, batch number, validity data such as expiration date, and references to further digital media such as Internet links to packaging leaflets or instructions for use or digital representations.

A digital signature involves the data pertaining to the clear identity, preferably the digital representation for the clear identity, more preferably the cryptographic hash for the clear identity, and the optional other information being digitally signed using a private key of the manufacturer or distributor of the physical object.

The private key is preferably known exclusively to the manufacturer or distributor of the physical object. The digital signature thus cannot usually be generated by outsiders.

The private key of the manufacturer or distributor of the physical object preferably has an associated public key by means of a digital certificate. This digital certificate is normally issued by a public certificate authority.

The public key and the related digital certificate can be used to clearly demonstrate the authenticity of the digital signature without knowing the private key of the manufacturer or distributor of the physical object. The public key can be incorporated into the unique code as well. The public key can also be stored in a database.

The steps of signing at least the clear identity and optionally other information and producing the unique code preferably comprise the following steps:
extracting features, preferably production inaccuracies, from the at least one defined first area;
deriving the clear identity from the extracted features, preferably production inaccuracies;
computing a cryptographic hash for the clear identity and optionally other information;
encrypting the cryptographic hash using the private key of the manufacturer or distributor of the physical object; and
producing the unique code.

The private key preferably has an associated public key by means of a digital certificate, as described above.

The same specifications as described above preferably apply here to the extraction of the features, preferably product inaccuracies, in order to be able to ensure that the extracted features, preferably product inaccuracies, are comparable.

The public key is preferably produced by the natural or legal person. A certificate signature request, normally to a certificate authority, is preferably used to issue a digital certificate that contains the public key, the metadata pertaining to the person and a digital signature by way of a cryptographic hash of the two pieces of information. This digital certificate is normally provided to the person. For each digital signature, said person preferably supplies the digital certificate as well, allowing any examining authority to verify the digital signature using the digital certificate.

The selection of the encryption algorithm for encrypting the cryptographic hash is optional. However, it is advisable to adhere to the specifications of relevant bodies, such as the National Institute of Standards and Technology (NIST), the Bundesamt für Sicherheit in der Informationstechnik [German Federal Office for Information Security] (BSI) or other authorities/bodies. The encryption algorithms change over time, the key lengths are continually adjusted by said bodies and recommendations for certain periods of time are provided. Shorter key lengths are normally adequate for shorter periods of time in which the inspection is performed, and relevant e.g. for physical objects with a very short life. Longer key lengths are advantageous for physical objects with a longer life, on the other hand.

In a next step, a unique code is produced that contains at least the clear identity, the optional other information and the digital signature.

This can be accomplished by preferably first digitally signing at least some of the data pertaining to the clear identity.

The digital signature allows the clear marking of the present inventive method to be used as secure and clear marking.

Owing to the size of the dataset, especially as a result of the clear identity, the unique code is preferably a multidimensional code, in order to be able to print the unique code onto at least one surface of the physical object on as small an area as possible. The unique code is thus preferably printed onto at least one second area on at least one surface of the physical object as a multidimensional barcode, for example as a 2-dimensional barcode or 3-dimensional barcode, preferably as a grayscale barcode, multicolor barcode or watermark-modified barcode, for example a 2-dimensional barcode, or a 3-dimensional barcode, preferably a grayscale barcode or multicolor barcode, or a watermark-modified 2- or 3-dimensional barcode.

The second area printed with the unique code is preferably in local proximity to the at least one defined first area.

It is preferred for the printed unique code to adjoin the at least one defined first area or to overlap the at least one defined first area.

The printed unique code can adjoin or overlap one or more sides of the at least one defined first area. For example, the printed unique code can enclose all sides of the at least one defined first area or can overlap on all sides.

In the case of an overlap, this is preferably in the range from 1 to 100%, such as 10% to 100%, preferably from 25% to 100%, more preferably from 50% to 100%, most preferably from 75% to 100%.

In the case of an overlap, it is necessary to ensure that both the at least one defined first area and the printed unique code on the second area can be read independently of one another and without interference.

The unique code can be printed onto at least one second area on at least one surface of the physical object using any standard method. Suitable methods for printing on at least one surface of a physical object using at least one printing composition are described above and can also be used here.

Another aspect of the present invention relates to a method for identifying a physical object that has been marked using the method of clear marking as described herein, the method containing the following steps:
scanning the printed unique code containing at least the clear identity, the optional other information and the digital signature;
reading the clear identity, the optional other information and the digital signature from the unique code;
verifying the digital signature;
checking whether the digital signature relates to the clear identity and the optional other information in the unique code;
extracting features, preferably production inaccuracies, from the at least one defined first area;
comparing the extracted features, preferably extracted production inaccuracies, against the clear identity that has been read from the unique code.

First, the printed unique code containing at least the clear identity, the optional other information and the digital signature is scanned and the clear identity, the optional other information and the digital signature are read.

This is accomplished by preferably first checking the digital certificate and therefore the identity of the certificate owner and the validity. If the digital certificate is valid, the public key is read from the certificate and this is used to decrypt the digital signature.

The decryption preferably results in the cryptographic hash for the contents of the signed information, which has been signed by the authenticated person.

Furthermore, the contents of the unique code, specifically the clear identity and the optional other information, are preferably likewise used to compute a cryptographic hash and to compare same with the decrypted cryptographic hash from the preceding step. If the two match, the signature is valid.

The step of verifying the digital signature thus preferably comprises the following steps:
reading the public key associated with the private key of the manufacturer or distributor of the physical object by means of a digital certificate; and
verifying the digital signature using the public key.

If the digital signature is valid, the last step further comprises extracting the features, preferably production inaccuracies, from the at least one defined first area and comparing them against the clear identity that has been read from the unique code. If they match, object authentication is complete. More features, preferably production inaccuracies, than are recorded in the clear identity can be extracted here. A physical object is deemed authenticated in this case if the features recorded in the clear identity are found in the features extracted to identify the physical object.

The inventive method can thus be used for securely and clearly marking a physical object.

The printed unique code is preferably scanned using the standard scanners suitable for this purpose, for example barcode scanners suitable for this purpose, which are capable of scanning and reading multidimensional barcodes, such as grayscale barcodes, multicolor barcodes or watermark-modified barcodes.

In the step of extracting the features, preferably production inaccuracies, from the at least one defined first area, the same steps and scales are preferably applied as described above for extracting the features, preferably production inaccuracies, from the at least one defined first area while marking the physical object. Furthermore, the same devices or devices having comparable equipment, resolution and accuracy are preferably used. Suitable devices are standard imaging devices, for example cameras, industrial cameras, NIR cameras, spectrometers, or else smart devices, such as smartphones or tablets.

If marking the physical object has resulted in production inaccuracies in the spectral range up to 3000 nm, preferably up to 1800 nm, more preferably up to 1400 nm, most preferably 1100 nm, being extracted, the step also comprises irradiating the at least one defined first area with photons and extracting features, preferably product inaccuracies, in the spectral range up to 3000 nm, preferably up to 1800 nm, more preferably up to 1400 nm, most preferably 1100 nm, as described above.

Finally, extracted features, preferably product inaccuracies, are compared against the data pertaining to the clear identity that have been read from the unique code.

The data pertaining to the clear identity are preferably available as a digital representation, preferably as a character string. This digital representation has preferably been produced from the extracted features, preferably production inaccuracies, and the optional other information by way of an algorithm, preferably a hash algorithm.

For comparison against the data pertaining to the clear identity, the freshly extracted features, preferably product inaccuracies, are preferably converted into a digital representation using the same algorithm, preferably the same hash algorithm, as for producing the digital representation pertaining to the unique identity.

The two digital representations are then preferably compared with one another.

This is preferably carried out using suitable software, which is suitable both for reading the digital representation pertaining to the clear identity and for creating a digital representation from the extracted features, preferably product inaccuracies, and comparing these digital representations against one another.

The steps of identifying the marked product that are described here are preferably performed using an electronic device suitable for this purpose. Suitable devices would be, for example, cameras, industrial cameras, NIR cameras, spectrometers, or else smart devices, such as smartphones or tablets.

The image processing, the reading of the data, the decryption and the comparison can be carried out using appropriate software, for example an app.

The inventive method can be used to clearly associate an entity comprising a number of physical objects. A possible additional digital signature, for example in the form of a unique code, as described above, allows the clear marking to be rendered additionally secure. The clarity results from every entity being able to be assigned an individual pattern of features, preferably production inaccuracies, which has preferably resulted from uncopiable random processes during the production of the physical object and the optional printing of the identification pattern. The features, preferably product inaccuracies, are therefore used as a physically unclonable function (PUF) as a second factor for a secure identity.

The inventive method for marking and identifying a physical object is therefore suitable for generating a physically unclonable function (PUF) pertaining to a secure and clear identity of physical objects and can therefore be used together with a digital signature in serialization systems, track and trace applications or for object authentication, for example document authentication.

The present invention also relates to a method for off-line verification of a physical object by using the methods for clearly marking physical objects and identifying a physical object as described herein, wherein no data for clear identification, preferably selected from features extracted from the defined first area of the physical object, data pertaining to the clear identity and possibly other object data, for example date of manufacture, place of manufacture, batch number, validity data such as expiration date, and references to further digital media such as Internet links to packaging leaflets or instructions for use or digital representations, are retrieved from a database for clearly identifying the physical object.

The features described herein for the inventive methods for clearly marking physical objects and identifying a physical object can also be applied to the inventive method for off-line verification of a physical object.

Although the inventive method for clearly marking printable physical objects and identifying a printable physical object is particularly suitable for off-line verification of a printable physical object, the inventive method can also be used in a method for hybrid off-line and online verification of a physical object, which also comprise, in addition to the steps described here, data for clear identification, preferably selected from some of the features extracted from the defined first area of the physical object, the clear identity and possibly other object data, for example date of manufacture, place of manufacture, batch number, validity data such as expiration date, and references to further digital media such as Internet links to packaging leaflets or instructions for use or digital representations, and/or other data for verifying the digital signature, for example public keys or digital certificates, being stored in a database for clearly identifying the product and being retrieved therefrom.

The features described herein for inventive methods for clearly marking physical objects and identifying a printable physical object can also be applied to the inventive method for hybrid off-line and online verification of a physical object.

In addition, the invention relates to a method for expanding the marking to include other unique codes, wherein at least some of the steps for marking the physical object and at least some of the steps for identifying the marked physical object in the methods as described herein are carried out and pursued by every inspection authority in the life cycle of a physical object, for example manufacturers, customs, wholesalers and traders, the signed clear identity in the case of the additional unique code that is to be newly put on relating not to extracted features but rather to a representation (for example hash value of the data) of the most recently added unique code.

This is accomplished by virtue of the inspection authority first carrying out the steps for identifying the marked physical object as described above. To update a code chain, the inspection authority preferably then marks the physical object at least using the following method steps:
producing a digital signature for the data pertaining to the clear identity;
producing a unique code containing the digital signature; and
printing the unique code onto at least one third area on at least one surface of the product.

The same procedure is preferably used for this as for the method steps
signing at least the clear identity and optionally other information in the form of a digital signature;
producing a unique code containing at least the clear identity, the optional other information and the digital signature;
printing the unique code onto at least one second area on at least one surface of the physical object
   of the method for clearly marking physical objects as described above.

The inspection authority therefore preferably uses this method to print another unique code onto at least one third area on at least one surface of the physical object, containing at least the digital signature of the inspection authority.

To continuously update the code chain, these steps are preferably carried out by all inspection authorities in the life cycle of a physical object, for example manufacturers, customs, wholesalers and traders.

This code chain allows a physical object to be tracked continuously.

Such a code chain is therefore particularly suitable for track & trace applications.

The inventive methods described herein for clearly marking physical objects and identifying a physical object can also be applied to the inventive method for expanding the marking to include other unique codes.

The invention also relates to a physical object having an optical security feature for clearly marking and identifying, preferably for clearly and securely marking and identifying, physical objects on at least one area of the surface of the physical object,
wherein the optical security feature comprises at least one first defined area and at least one second area having at least one printed unique code,
the at least one printed unique code containing a clear identity and optionally other information pertaining to the physical object and a digital signature of the clear identity and the optional other information,
the clear identity having been produced from features that have been extracted from the at least one first defined area.

The optical security feature is here preferably put onto the physical object, and used to mark and identify the individual physical object, using all of the inventive methods described herein.

The inventive methods include here the method for clearly marking physical objects as described herein, the method for identifying a physical object as described herein, the method for off-line verification of physical objects as described herein, the method for hybrid off-line and online verification of a physical object as described herein, and the method for expanding the marking to include other unique codes as described herein.

The optical security feature may thus also comprise codes that have been printed onto at least one surface of the physical object by the inspection authorities in the method for expanding the marking to include other unique codes.

Additionally, the invention relates to a serialization and/or track & trace system based on at least one optical security feature on at least one surface of a physical object as described herein.

Moreover, the invention relates to the use of an optical security feature on at least one surface of a physical object as described herein in a serialization and/or track & trace system and/or for object authentication, for example for document authentication.

Furthermore, the invention relates to the use of an optical security feature on at least one surface of a physical object as described herein for off-line verification and/or hybrid off-line and online verification of a physical object.

Finally, the invention relates to the use of an optical security feature on at least one surface of a physical object as described herein in a method for expanding the marking to include other unique codes as described herein.

The features described herein for inventive methods and the optical security feature can also be applied to the inventive serialization and/or track & trace system and the inventive uses.

1: A method for marking physical objects, containing the following steps:
defining a first area on at least one surface of a physical object;
extracting features from the selected area;
producing a clear identity from at least some of the extracted features;
signing at least the clear identity and optionally other information in the form of a digital signature;
producing a unique code containing at least the clear identity, the optional other information and the digital signature;
printing the unique code onto at least one second area on at least one surface of the physical object.

2: The method as claimed in claim 1, wherein the features are production inaccuracies on the at least one defined first area, the production inaccuracies including unintentional and intrinsic variances of the surface of the physical object and/or substrate itself and/or unintentional and intrinsic variances in a printed printing composition and/or unintentional and intrinsic variances in the printed image of an identification pattern printed using the printing composition.

3: The method as claimed in claim 1, wherein at least one portion of the defined first area is printed with at least one printing composition.

4: The method as claimed in claim 3, wherein the printing composition(s) contains photoluminescent materials that emit radiation in the range up to 3000 nm, under photon excitation, the photoluminescent materials including semiconducting inorganic nanocrystals, perovskites, I-VI semiconductors, II-VI semiconductors, III-V semiconductors, IV-VI semiconductors, I-III-VI semiconductors, carbon dots and mixtures thereof.

5: The method as claimed in claim 1, wherein the other information to be signed optionally includes, in addition to the extracted features, at least one other object datum, for example date of manufacture, place of manufacture, batch number, validity data such as expiration date, and references to further digital media such as Internet links to packaging leaflets or instructions for use or digital representations.

6: The method as claimed in claim 1, wherein the clear identity is a digital representation produced from the extracted features and other information by way of an algorithm.

7: The method as claimed in claim 1, wherein the steps of signing at least the clear identity and optionally other information and producing the unique code comprise the following steps:
extracting features from the at least one defined first area;
deriving the clear identity from the extracted features;
computing a cryptographic hash for the clear identity and optionally other information;
encrypting the cryptographic hash using the private key of the manufacturer or distributor of the physical object; and
producing the unique code.

8: The method as claimed in claim 7, wherein the private key has an associated public key by means of a digital certificate.

9: The method as claimed in claim 1, wherein the second area printed with the unique code is in local proximity to the defined first area, the printed unique code adjoining the defined first area or overlapping the defined first area, in the range from 1% to 100%.

10: The method as claimed in claim 1, wherein the unique code is printed onto the at least one second area on at least one surface of the physical object as a multidimensional barcode.

11: A method for identifying a physical object that has been marked using the method of clear marking as claimed in claim 1, the method containing the following steps:
scanning the printed unique code containing at least the clear identity, the optional other information and the digital signature;
reading the clear identity, the optional other information and the digital signature from the unique code;
verifying the digital signature;
checking whether the digital signature relates to the clear identity and the optional other information in the unique code;
extracting features from the at least one defined first area;
comparing the extracted features against the clear identity that has been read from the unique code.

12: The method as claimed in claim 11, wherein the verification of the digital signature comprises the following steps:
reading the public key associated with the private key of the manufacturer or distributor of the physical object by means of a digital certificate; and
verifying the digital signature using the public key.

13: The method as claimed in claim 11, wherein an electronic smart device having suitable software is used for the individual steps.

14: The method claimed in claim 11, wherein the at least one defined first area is irradiated with photons and the features are extracted from the at least one defined first area in the spectral range up to 3000 nm.

15: A method for off-line verification of a physical object by using the methods as claimed in claim 11, wherein no data for clear identification, selected from features extracted from the defined first area of the physical object, data pertaining to the clear identity and possibly other object data are retrieved from a database for clearly identifying the physical object.

16: A method for hybrid off-line and online verification of a physical object by using the methods as claimed in claim 11, wherein some of the data for clear identification, selected from at least some of the features extracted from the defined first area of the physical object, and/or other data for verifying the digital signature are stored in a database and retrieved therefrom.

17: A method for expanding the marking to include other unique codes, wherein at least some of the steps for marking the physical object and at least some of the steps for identifying the marked physical object in the methods as claimed in claim 11 are carried out and pursued by every inspection authority in the life cycle of a physical object, the signed clear identity in the case of the additional unique code that is to be newly put on relating not to extracted features but rather to a representation of the most recently added unique code.

18: A physical object having an optical security feature for clearly marking and identifying physical objects on at least one area of the surface of the physical object,
wherein the optical security feature comprises at least one first defined area and at least one second area having at least one printed unique code,
the at least one printed unique code containing a clear identity and optionally other information pertaining to the physical object and a digital signature of the clear identity and the optional other information,
the clear identity having been produced from features that have been extracted from the at least one first defined area.

19: A serialization and/or track & trace system based on at least one optical security feature on at least one surface of a physical object as claimed in claim 18.

20: The physical object of claim 18, wherein the optical security feature is used in a serialization and/or track & trace system and/or for object authentication, and/or for off-line verification and/or hybrid off-line and online verification of a physical object, and/or in a method for expanding the marking to include other unique codes.

21-22. (canceled)

23: The method as claimed in claim 1, wherein the at least one defined first area is irradiated with photons and the features are extracted from the at least one defined first area in the spectral range up to 3000 nm.
